(19) United States
(12) Patent Application Publication
(10) Pub. No.: US 2026/0276382 A1
(43) Pub. Date: Sep. 17, 2026

(54) COMPACT, THREE-AXIS GYROSCOPE WITH A COUPLING STRUCTURE

(71) Applicant: Robert Bosch GmbH, Stuttgart (DE)

(72) Inventors: Andreas Lassl, Korntal-Muenchingen (DE); Andreas Christian Mayer, Ebersbach An Der Fils (DE); Jana Ochs, Reichenau (DE); Martin Putnik, Rottenburg Am Neckar (DE); Matthias Wenzel, Marbach Am Neckar (DE); Nils Felix Kuhlmann, Ehningen (DE); Thorsten Balslink, Kirchentellinsfurt (DE); Tobias Hiller, Reutlingen (DE)

(21) Appl. No.: 19/546,516

(22) Filed: Feb. 23, 2026

(30) Foreign Application Priority Data
Mar. 12, 2025 (DE) 10 2025 109 485.3

(51) Int. Cl. G01C 19/5733

(52) U.S. Cl. CPC G01C 19/5733

(57) ABSTRACT

A three-axis gyroscope. The gyroscope includes a first rocker structure and a second rocker structure and a coupling structure having a coupling element and a further coupling element, wherein the coupling element has at least one mass element and at least one spring element, wherein the further coupling element has at least one further mass element and at least one further spring element, wherein the coupling element exists as a linkage and/or as a series of the at least one mass element with the at least one spring element, and/or the further coupling element exists as a further linkage and/or as a further series of the at least one further mass element with the at least one further spring element.

### CROSS REFERENCE

The present application claims the benefit under 35 U.S.C. § 119 of Germany Patent Application No. DE 10 2025 109 485.3 filed on Mar. 12, 2025, which is expressly incorporated herein by reference in its entirety.

### FIELD

The present disclosure related to a three-axis gyroscope having a first rocker structure and a second rocker structure. Certain of such three-axis gyroscopes, which use two rocker structures to achieve rotation acceleration-robust behavior, are generally conventional. In certain conventional gyroscopes, the detection mode for detecting a Z-yaw rate and an additionally occurring parallel mode have, however, very similar natural frequencies (and correspondingly very similar resonant frequencies) due to their sensor topology so that external vibrations and rotational accelerations can generate interference signals that are superimposed on the measurement signal or misinterpreted as it and cannot be separated by filtering due to the similar natural frequencies.

### SUMMARY

An object of the present disclosure is to provide a three-axis gyroscope that has a first rocker structure and a second rocker structure and that does not have the above-described disadvantages.

A three-axis gyroscope according to an example embodiment of the present disclosure has a first rocker structure and a second rocker structure and a coupling structure having a coupling element and a further coupling element, wherein the coupling element has at least one mass element and at least one connecting element, wherein the further coupling element has at least one further mass element and at least one further connecting element, characterized in that the coupling element is a linkage and/or a series of the at least one mass element with the at least one connecting element and/or the further coupling element is a further linkage and/or a further series of the at least one further mass element with the at least one further connecting element. The three-axis gyroscope according to the present disclosure has the advantage that it enables a much more compact design and robustness, since it utilizes the compactness of a linkage and/or series of simple mass elements and connecting elements.

Advantageous embodiments and developments can be found in the disclosure herein.

According to an advantageous embodiment of the three-axis gyroscope according to the present disclosure, the three-axis gyroscope has a coupling structure which is located and/or arranged in the same material layer, in particular in the same polysilicon layer, as a rotor and/or a further rotor of the three-axis gyroscope.

According to a further advantageous embodiment of the three-axis gyroscope according to the present disclosure, the three-axis gyroscope has a coupling structure that is arranged and/or extends outside the rotor and/or outside the further rotor.

According to a further advantageous embodiment of the three-axis gyroscope according to the present disclosure, the three-axis gyroscope has a coupling structure that is arranged and/or extends along the rotor and/or along the further rotor.

According to a further advantageous embodiment of the three-axis gyroscope according to the present disclosure, the coupling element, in particular at one end of the linkage or at one end of the series, is connected to the first rocker structure via a first coupling rocker connection structure and, in particular at the other end of the linkage or at the other end of the series, is connected to the second rocker link structure via a second coupling rocker link structure, wherein the further coupling element, in particular at one end of the further linkage or at one end of the series, is connected to the first rocker link structure via a first further coupling rocker link structure and, in particular at the other end of the further linkage or at the other end of the series, is connected to the second rocker structure via a second further coupling rocker connection structure, wherein the first coupling rocker connection structure and/or the first further coupling rocker connection structure and/or the second coupling rocker connection structure and/or the second further coupling rocker connection structure is designed as a relieving structure, in particular as a relieving structure with a smaller spring stiffness than the connecting elements and/or the further connecting elements of the coupling element or the further coupling element.

According to a further advantageous embodiment of the three-axis gyroscope according to the present disclosure, the three-axis gyroscope has, for the realization of a Z-channel for measuring the yaw rate about a Z-axis, a first partial oscillator and a second partial oscillator and a first further partial oscillator and a second further partial oscillator, wherein in particular, the partial oscillators and the further partial oscillators can perform a movement outside the main extension plane of the three-axis gyroscope, in particular outside the XY plane, by means of at least one first coupling rocker connection structure and/or first further coupling rocker connection structure and/or second coupling rocker connection structure and/or second further coupling rocker connection structure designed as a relieving structure.

According to a further advantageous embodiment of the three-axis gyroscope according to the present disclosure, the gyroscope has a plane of symmetry oriented parallel to the XY plane or the XY plane itself as a plane of symmetry.

According to a further advantageous embodiment of the three-axis gyroscope according to the present disclosure, the coupling structure has bending elements and/or rocker elements.

According to a further advantageous embodiment of the three-axis gyroscope according to the present disclosure, the three-axis gyroscope has a coupling structure which is designed as an outer frame and/or has at least one substrate anchoring, preferably four substrate anchorings, in each coupling element or further coupling element.

According to a further advantageous embodiment of the three-axis gyroscope according to the present disclosure, instead of a simple embodiment of at least one of its components, the three-axis gyroscope has multiple embodiments of these components which are in particular arranged parallel to each other and/or interconnected and/or aligned and/or which are in particular arranged and/or interconnected and/or aligned in a linkage.

Exemplary embodiments are illustrated in the figures and explained in more detail in the following description.

### BRIEF DESCRIPTION OF THE DRAWINGS

FIG. 1 shows, in a schematic representation, a three-axis gyroscope according to the related art.

FIG. 2 shows, in a schematic representation, a three-axis gyroscope in a first example embodiment according to the present disclosure.

FIG. 3 shows, in a schematic representation, the z-detection modes and z-parallel modes of a three-axis gyroscope according to the present disclosure in accordance with the related art (a and b) in comparison to the first example embodiment of the present disclosure (c and d).

FIG. 4 shows, in a schematic representation, five different example embodiments (a, b, c, d and e) of coupling rocker connection structures of a three-axis gyroscope according to the present disclosure.

FIG. 5 shows, in a schematic representation, seven different example embodiments (a, b, c, d, e, f and g) of mass elements of a coupling element of a coupling structure of a three-axis gyroscope according to the present disclosure.

FIG. 6 shows, in a schematic representation, five different example embodiments (a, b, c, d and e) of connecting elements of a coupling element of a coupling structure of a three-axis gyroscope according to the present disclosure.

FIG. 7 shows, in a schematic representation, six different example embodiments (a, b, c, d, e and f) of mass elements of a coupling element of a coupling structure of a three-axis gyroscope according to the present disclosure.

### DETAILED DESCRIPTION OF EXAMPLE EMBODIMENTS

In the various figures, identical parts are always provided with the same reference signs and are therefore generally also named or mentioned only once.

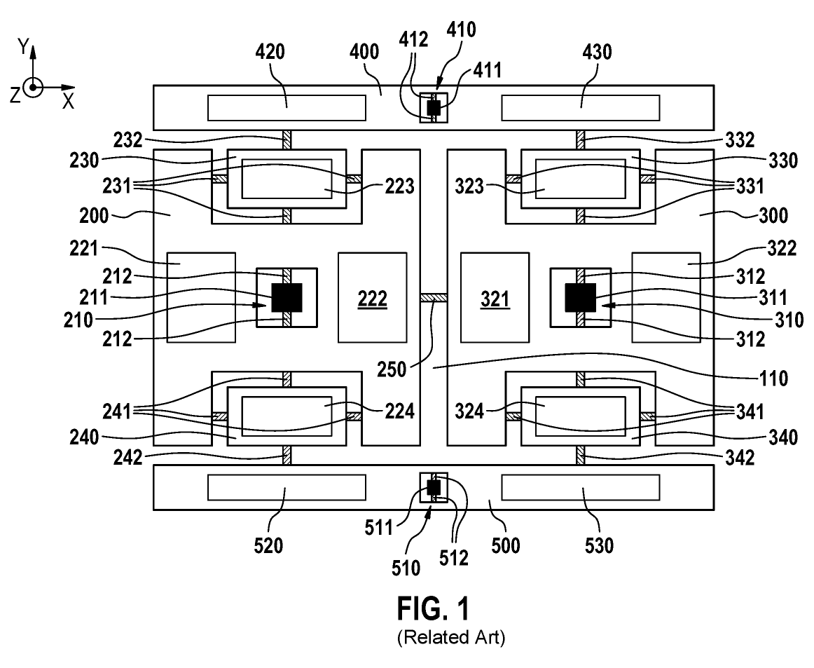

FIG. 1 shows, in a schematic representation, a three-axis gyroscope 100 according to the related art. The illustrated three-axis micromechanical gyroscope 100 allows the yaw rates, i.e. the angular velocities, about three orthogonal spatial axes – an X-axis, a Y-axis and a Z-axis – to be determined simultaneously. The illustrated gyroscope 100 can be made, for example, of silicon or silicon oxides or other semiconductors or oxides or oxide ceramics by means of physical or chemical vapor deposition processes and by means of various etching processes on a substrate 110. The three-axis gyroscope 100 has a rotor 200 and a further rotor 300 for measuring the yaw rate about the X-axis, and electrodes 221, 222, 223, 224 or further electrodes 321, 322, 323, 324 arranged between rotor 200 or further rotor 300 and substrate 110, wherein a first electrode 221 and a second electrode 222 of the rotor 200 are located on opposite sides of the rotor 200, or a first further electrode 321 and a second further electrode 322 of the further rotor 300 are located on opposite sides of the further rotor 300. The rotor 200 or the further rotor 300 each have a substantially square outline or an H-shaped outline, and/or the rotor 200 and further rotor 300 are arranged side by side such that two sides of the square outline or the H-shaped outline face each other, while two other sides face away from each other. The rotor 200 is connected to the further rotor 300 via a rotor connection structure 250 designed as a spring-loaded, single or multiple bar, wherein the rotor connection structure 250 is arranged between the mutually facing sides of the rotor 200 and of the further rotor 300. The rotor 200 or the further rotor 300 is connected to the substrate 110 via a rotor-substrate connection 210, which has a rotor-substrate anchoring 211 and a rotor-substrate spring structure 212, or a further rotor-substrate connection 310, which has a further rotor-substrate anchoring 311 and a further rotor-substrate spring structure 312, wherein an integral connection exists between the rotor 200 and the substrate 110 or between the further rotor 300 and the substrate 110 through the rotor-substrate anchoring 211 or through the further rotor-substrate anchoring 311. The rotor-substrate spring structure 212 and/or the further rotor-substrate spring structure 312 can be designed as a spring-loaded single or multiple bar. To measure a yaw rate around the Z-axis, the three-axis gyroscope 100 has a first partial oscillator 230, a second partial oscillator 240, a first further partial oscillator 330 and a second further partial oscillator 340. The rotor 200 or the further rotor 300 has a first and a second or a first further and a second further recess which are arranged on opposite sides of the rotor or the further rotor and each have a rectangular shape. The first partial oscillator 230 or the second partial oscillator 240 is arranged in the first or second recess. The first further partial oscillator 330 or the second further partial oscillator 340 is arranged in the first further or second further recess. The partial oscillators 230,240, 330, 340 can each be designed as rectangular plate elements which fill the particular recess except for the remaining gap to the rotor 200 or to the further rotor 300. The first partial oscillator 230 or the second partial oscillator 240 is connected to the rotor 200 via a first rotor-partial oscillator connection structure 231 having three spring elements or a second rotor-partial oscillator connection structure 241 also having three spring elements. Between the first partial oscillator 230 and the substrate 110, or between the second partial oscillator 240 and the substrate 110, there is a third electrode 223 or a fourth electrode 224 for measuring a yaw rate around the Y-axis. Between the first further partial oscillator 330 and the substrate 110, or between the second partial oscillator 340 and the substrate 110, there is a third further electrode 323 or a fourth further electrode 324 for measuring a yaw rate around the Y-axis. The first further partial oscillator 330 or the second further partial oscillator 340 is connected to the further rotor 200 via a first further rotor-partial oscillator connection structure 331 having three spring elements or a second further rotor-partial oscillator connection structure 341 also having three spring elements. Through the rotor-partial oscillator connection structure 231, 241 and the further rotor-partial oscillator connection structures 331, 341, when a yaw rate about the Z-axis is present and as a result of the drive movement of the three-axis gyroscope, which has a counter-clockwise rotational oscillation of the rotor 200 and of the further rotor 300, the partial oscillators 230, 240 and further partial oscillators 330, 340 are driven to generate a radial velocity vector in the co-rotating reference system (here mainly along the X-axis), thereby causing a movement as a result of Coriolis forces (here mainly along the Y-axis). The three-axis gyroscope 100 also has a first rocker structure 400 and a second rocker structure 500 which serve to couple the partial oscillators 230, 240 and the further partial oscillators 330, 340 and therefore to couple the Z-channels of the three-axis gyroscope 100. The first rocker structure 400 or the second rocker structure 500 has a first rocker-substrate connection 410 comprising a first rocker-substrate anchoring 411 and a first rocker-substrate spring structure 412, or a second rocker-substrate connection 510 comprising a second rocker-substrate anchoring 511 and a second rocker-substrate spring structure 512, about which the first rocker structure 400 or the second rocker structure 500 is rotatably arranged, such that a first axis of rotation of the first rocker structure 400 or a second axis of rotation of the second rocker structure 500 passes through the first rocker-substrate connection 410 or through the second rocker-substrate connection 510. For coupling purposes, the first partial oscillator 230 or the second partial oscillator 240 is connected to the first rocker structure 500 or to the second rocker structure 600 via a first partial oscillator rocker connection structure 232 or a second partial oscillator rocker connection structure 242, and the first further partial oscillator 330 and the second further partial oscillator 340 are connected to the first rocker structure 500 or to the second rocker structure 600 via a first further partial oscillator rocker connection structure 332 or a second further partial oscillator rocker connection structure 342. The first partial oscillator rocker connection structure 232 and the first further partial oscillator rocker connection structure 332, each of which can be designed as spring elements, couple an opposing deflection of the first partial oscillator 230 and of the first further partial oscillator 330 to a rotational movement (or torsional vibration) of the first rocker structure 400. The second partial oscillator rocker connection structure 242 and the second further partial oscillator rocker connection structure 342, each of which can be designed as spring elements, couple an opposing deflection of the second partial oscillator 240 and of the second further partial oscillator 340 to a rotational movement (or torsional vibration) of the second rocker structure 500. In a detection mode for a yaw rate about the Z-axis, the Coriolis forces occurring during the rotation and acting on the partial oscillators 230, 240 and further partial oscillators 330, 340 cause an alternating opening movement of the rocker structures 400, 500 on one side of the three-axis gyroscope 100 and a closing movement on the opposite side (i.e., the angle formed by the first rocker structure 400 and the second rocker structure 500 increases and decreases in an oscillation). In a parallel mode, the forces acting on the partial oscillators 230, 240 and on the further partial oscillators 330, 340 cause an oscillation of the rocker structures 400, 500 in which the angle formed by the rocker structures remains substantially zero. The first rocker structure 400 or the second rocker structure 500 has a fifth electrode 420 and a sixth electrode 430 or a seventh electrode 520 and an eighth electrode 530 for detecting the yaw rate around the Z-axis, which are arranged between the first rocker structure 400 and the substrate 110 or between the second rocker structure 500 and the substrate 110. The rotor 200 and the additional rotor 300 allow the measurement of yaw rates along two axes (here the X-axis and the Y-axis), read out via the electrodes 221, 222 and the further electrodes 321, 322 (tilting along the x-axis) and the electrodes 223, 224 and the further electrodes 323, 324 (tilting along the y-axis). The partial oscillators 230, 240 and the further partial oscillators 330, 340 can start oscillating independently of each other due to their connection to the rotor or to the further rotor.

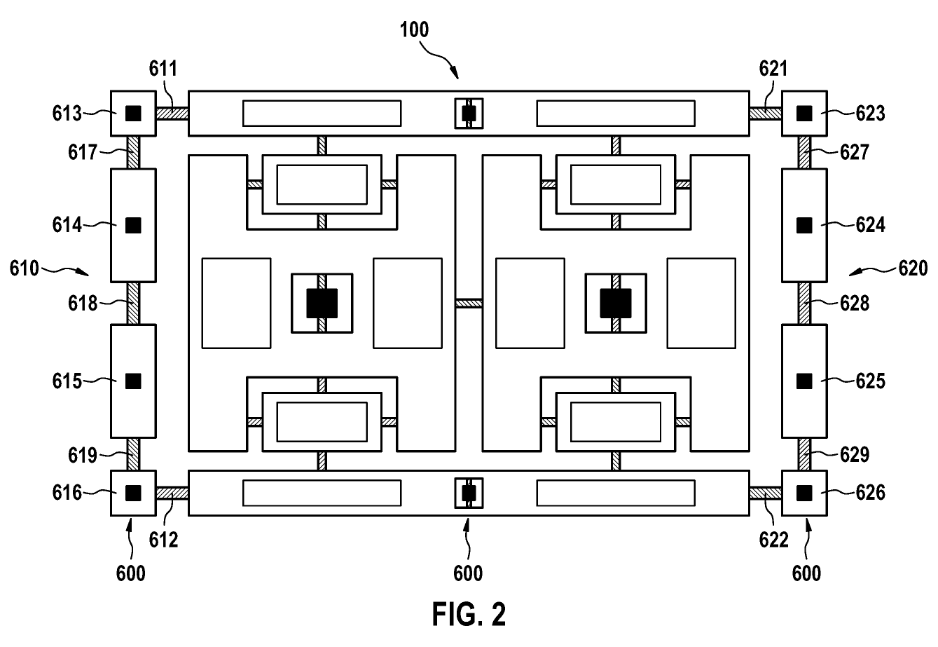

FIG. 2 shows a schematic representation of a three-axis gyroscope 100 in a first embodiment according to the present disclosure. The three-axis gyroscope 100 has a coupling structure 600 comprising a coupling element 610 and a further coupling element 620. The coupling element 610 has four mass elements 613, 614, 615, 616, a first mass element 613, a second mass element 614, a third mass element 615 and a fourth mass element 616 and three connecting elements 617, 618, 619, a first connecting element 617, a second connecting element 618 and a third connecting element 619, wherein the connecting elements are designed as spring-loaded connections or as spring elements. The further coupling element 620 has four further mass elements 623, 624, 625, 626, a first further mass element 623, a second further mass element 624, a third further mass element 625 and a fourth further mass element 626 and three further connecting elements 627, 628, 629, a first further connecting element 627, a second further connecting element 628 and a third further connecting element 629, wherein the connecting elements 617, 618, 619 and further connecting elements 627, 628, 629 are designed as spring-loaded connecting elements. The coupling element 610 or the further coupling element 620 exists as a linkage of the mass elements 613, 614, 615, 616 and the connecting elements 617, 618, 619, or as a linkage of the further mass elements 623, 624, 625, 626 and the connecting elements 627, 628, 629. In the coupling element 610, the first connecting element 617 connects the first mass element 613 with the second mass element 614, the second connecting element 618 connects the second mass element 614 with the third mass element 615, and the third connecting element 619 connects the third mass element 615 with the fourth mass element 616. In the further coupling element 620, the first further connecting element 627 connects the first further mass element 623 with the second further mass element 624, the second further connecting element 628 connects the second further mass element 624 with the third further mass element 625, and the third further connecting element 629 connects the third further mass element 625 with the fourth further mass element 626. The coupling element 610 corresponds to an alternating or consecutive series or linkage of the mass elements 613, 614, 615, 616 and connecting elements 617, 618, 619, and the further coupling element 620 corresponds to an alternating or consecutive series or linkage of the further mass elements 623, 624, 625, 626 and the further connecting elements 627, 628, 629. The further coupling element is arranged diametrically opposite the coupling element in the three-axis gyroscope or next to the opposite sides of the rotor 200 and the further rotor 300. The coupling element 610 or the further coupling element 620 is connected to the first rocker structure 400 via a first coupling rocker connection structure 611 or a first further coupling rocker connection structure 621 and to the second rocker structure 500 via a second coupling rocker connection structure 612 or a second further coupling rocker connection structure 622. The first coupling rocker connection structure 611 or the first further coupling rocker connection structure 621 is arranged at opposite ends of the linkage or series of the mass elements 613, 614, 615, 616 and the connecting elements 617, 618, 619 or of the further mass elements 623, 624, 625, 626 and of the further connecting elements 627, 628, 629 with respect to the second coupling rocker connection structure 621 or the second further coupling rocker connection structure 622. The coupling rocker connection structure 611, 612 and the further coupling rocker connection structure 621, 622 are designed as spring connections or spring elements. The coupling structure 600 ensures that the natural frequencies of the detection mode and the parallel mode can be separated to such an extent by suitable selection of the mass elements 613, 614, 615, 616 and further mass elements 623, 624, 625, 626 and the connecting elements 617, 618, 619 and further connecting elements 617, 618, 619 as well as the coupling rocker connection structures 611, 612 and the further coupling rocker connection structures 621, 622 that the associated, generated electrode signals can be easily separated and/or filtered.

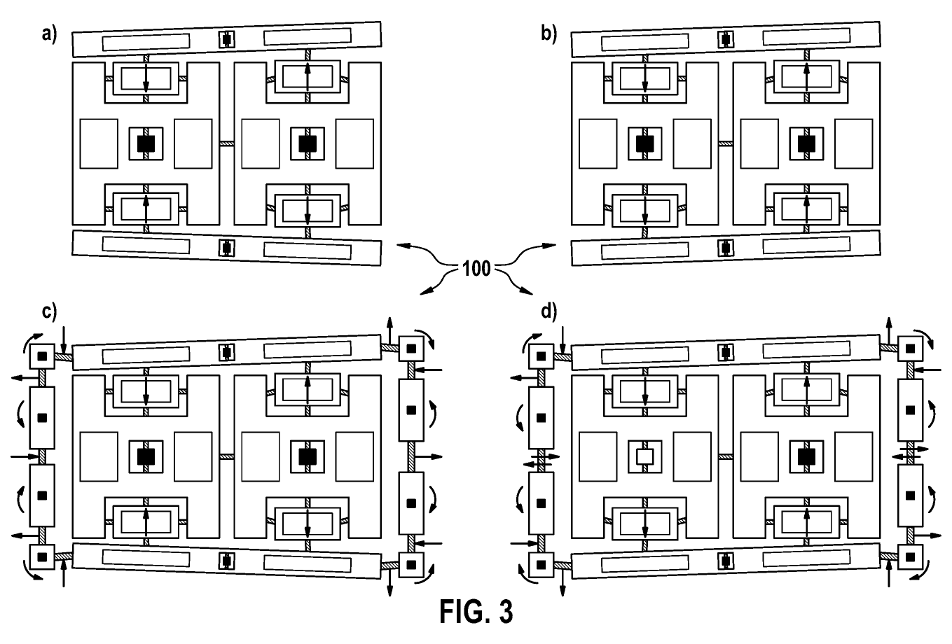

FIG. 3 shows, in a schematic representation, the z-detection modes or z-parallel modes of a three-axis gyroscope 100 in the related art (upper left illustration “a” or upper right illustration “b”) in comparison to the first example embodiment of the present disclosure (lower left illustration “c” or upper right illustration “d”). In the upper left illustration, the opening, i.e. the formed angle, between the first rocker structure 400 and the second rocker structure 500 is shown, which opening is characteristic of the detection mode for the z-yaw rate. In the upper right illustration, the parallel alignment, i.e., the formed angle is equal to zero, is shown between the first rocker structure 400 and the second rocker structure 500, which alignment is characteristic of the parallel mode, which mode is typically excited by rotational accelerations about the Z-axis. In contrast, the lower left and lower right illustrations show the detection mode and the parallel mode in a three-axis gyroscope 100 according to the present disclosure. Due to the mechanical coupling by means of the coupling element 610 and the further coupling element 620, the natural frequencies (and resonance frequencies) of the detection mode and of the parallel mode are so far apart that the associated signals at the electrodes can be easily separated (or disconnected) and/or filtered.

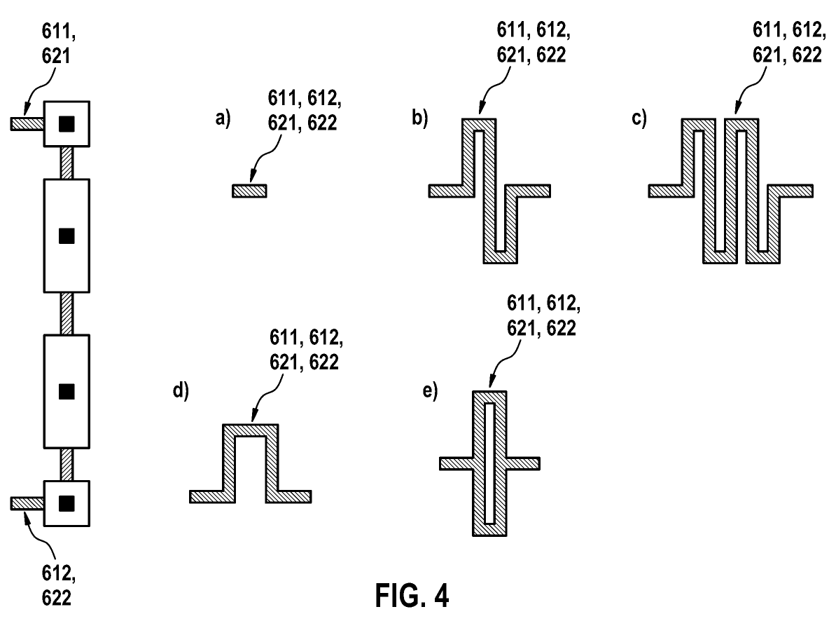

FIG. 4 shows, in a schematic representation, five different embodiments (“a”, “b”, “c”, “d” and “e”) of coupling rocker connection structures 611, 612, 621, 622 according to the present disclosure. Each of the following embodiments can be either an embodiment of the first coupling rocker connection structure 611, and/or the first further coupling rocker connection structure 621, and/or the second coupling rocker connection structure 612, and/or the second further coupling rocker connection structure 622. The embodiment “a” corresponds to a simple, spring-loaded bar structure. The embodiment “b” corresponds to a meandering spring structure with a simple meander, i.e. with two opposing U-shaped loop structures. The embodiment “c” corresponds to a meandering spring structure with a dual or double meander, i.e. with two pairs of opposing U-shaped loop structures. The embodiment “d” corresponds to a spring-loaded, U-shaped loop structure. The embodiment “e” corresponds to a spring-loaded, circular loop structure or a phi-shaped (in the form of the Greek letter Phi) spring structure.

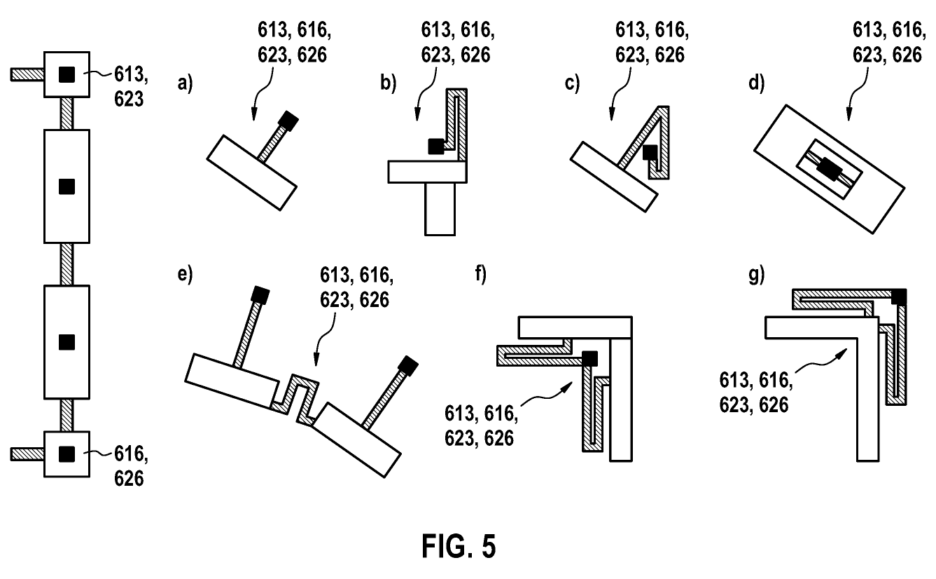

FIG. 5 shows, in a schematic representation, seven different embodiments (“a”, “b”, “c”, “d”, “e”, “f” and “g”) of the mass elements 613, 616 of the coupling element 610 of the coupling structure 600 and of the further mass elements 623, 626 of the further coupling element 620 of the coupling structure 600 according to the present disclosure. Each of the following embodiments can be an embodiment of a mass element 613, 616 arranged at the ends of the linkage or series of the mass elements 613, 614, 615, 616 and connecting elements 617, 618, 619 of the coupling element 610 and/or an embodiment of a further mass element 623, 626 arranged at the ends of the linkage or series of the further mass elements 623, 624, 625, 626 and further connecting elements 627, 628, 629 of the further coupling element 620. The embodiment “a” corresponds to a construction consisting of a bar mass (or cuboid mass) oriented at an angle of substantially 45° to at least one plane of symmetry of the three-axis gyroscope 100 and a simple spring-loaded bar and a substrate anchoring arranged laterally to the bar mass. The embodiment “b” corresponds to a construction consisting of two bar masses (or cuboid masses) oriented perpendicularly to each other and a spring-loaded U-shaped loop structure with a substrate anchoring at one end of the U-shaped loop structure. The embodiment “c” corresponds to a construction consisting of a bar mass (or cuboid mass) oriented at an angle of substantially 45° to at least one plane of symmetry of the three-axis gyroscope 100 and a spring structure consisting of a bar spring oriented perpendicularly to the bar mass and a J-shaped spring structure, wherein the end of the arc of the J-shaped spring structure is connected to a substrate anchoring and the end of the straight portion is connected to an end of the bar spring. The embodiment “d” corresponds to a construction consisting of a bar mass (or cuboid mass) oriented at an angle of substantially 45° to at least one plane of symmetry of the three-axis gyroscope 100, with a rectangular recess in which a substrate anchoring connected to the bar mass via bar springs is located. The embodiment “e” corresponds to a construction of two bar masses (or cuboid masses) connected by a U-shaped spring structure, each having a bar spring extending perpendicularly from the bar mass and each having a substrate anchoring at its end. The embodiment “f” corresponds to a construction of two bar masses (or cuboid masses) that are oriented perpendicularly to each other and thereby form a right angle, wherein within the right angle, two spring-loaded U-shaped loop structures are arranged at right angles to each other and are connected at one end to a substrate anchoring. The embodiment “f” corresponds to a construction of two bar masses (or cuboid masses) that are oriented perpendicularly to each other and thereby form a right angle, wherein outside the right angle, two spring-loaded U-shaped loop structures are arranged at right angles to each other and are connected at one end to a substrate anchoring.

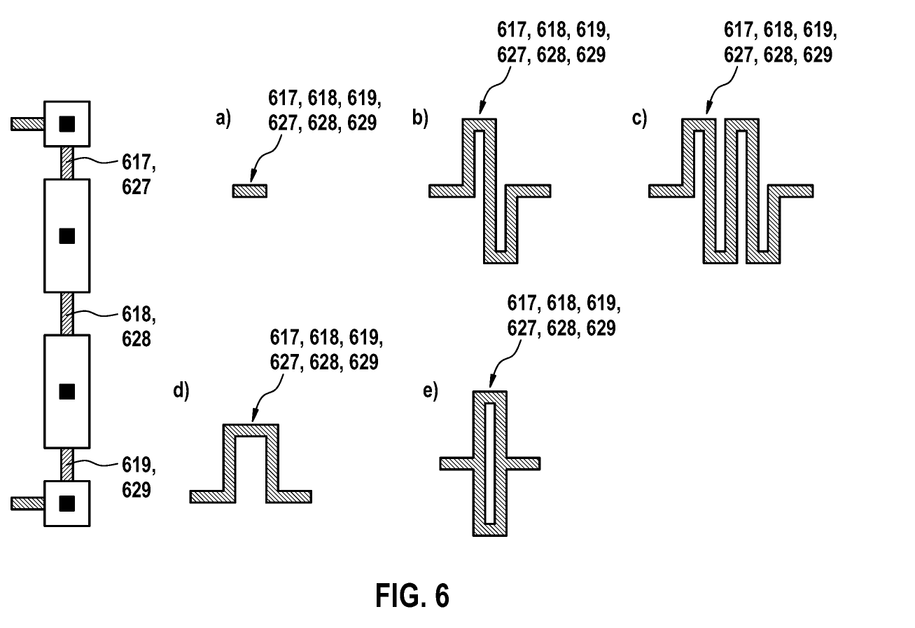

FIG. 6 shows, in a schematic representation, five different embodiments (“a”, “b”, “c”, “d” and “e”) of connecting elements 617, 618, 618 and further connecting elements 627, 628, 628 according to the present disclosure. Each of the following embodiments can be either an embodiment of the first connecting element 617 and/or of the second connecting element 618 and/or of the third connecting element 619 and/or of the first further connecting element 627 and/or of the second further connecting element 628 and/or of the third further connecting element 629. The embodiment “a” corresponds to a simple, spring-loaded bar structure. The embodiment “b” corresponds to a meandering spring structure with a simple meander, i.e. with two opposing U-shaped loop structures. The embodiment “c” corresponds to a meandering spring structure with a dual or double meander, i.e. with two pairs of opposing U-shaped loop structures. The embodiment “d” corresponds to a spring-loaded, U-shaped loop structure. The embodiment “e” corresponds to a spring-loaded, circular loop structure or a phi-shaped (in the form of the Greek letter Phi) spring structure.

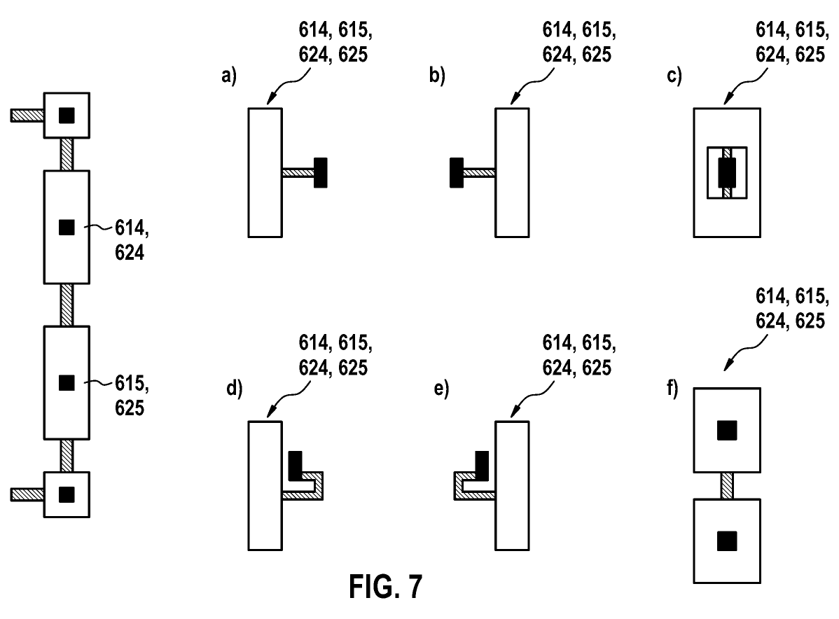

FIG. 7 shows, in a schematic representation, six different embodiments (“a”, “b”, “c”, “d”, “e”, “f” and “g”) of the mass elements 614, 615 of the coupling element 610 of the coupling structure 600 and of the further mass elements 624, 625 of the further coupling element 620 of the coupling structure 600 according to the present disclosure. Each of the following embodiments can be an embodiment of a mass element 614, 615 arranged within the linkage or series of the mass elements 613, 614, 615, 616 and connecting elements 617, 618, 619 of the coupling element 610, and/or an embodiment of a further mass element 624, 625 arranged within the linkage or series of the further mass elements 623, 624, 625, 626 and further connecting elements 627, 628, 629 of the further coupling element 620. The embodiment “a” corresponds to a construction consisting of a bar mass (or cuboid mass) (e.g. oriented in the Y direction with its longitudinal axis) and a simple spring-loaded bar oriented perpendicularly to the bar mass and extending from the rotor 200 and the further rotor 300, and a substrate anchoring arranged laterally to the bar mass and connected to the spring-loaded bar. The embodiment “b” corresponds to a construction consisting of a bar mass (or cuboid mass) (e.g. oriented in the Y direction with its longitudinal axis) and a simple spring-loaded bar oriented perpendicularly to the bar mass and pointing towards the rotor 200 and the further rotor 300, and a substrate anchoring arranged laterally to the bar mass and connected to the spring-loaded bar. The embodiment “c” corresponds to a construction consisting of a bar mass (or cuboid mass) (e.g. oriented in the Y direction with its longitudinal axis) with a rectangular recess and a substrate anchoring which is arranged in the recess and is connected to the bar mass via two simple, spring-loaded bars. The embodiment “d” corresponds to a construction consisting of a bar mass (or cuboid mass) (e.g. oriented in the Y direction with its longitudinal axis) and a spring-loaded, U-shaped loop structure oriented perpendicularly to the bar mass and extending from the rotor 200 and the further rotor 300, at the end of which a substrate anchoring is arranged. The embodiment “e” corresponds to a construction consisting of a bar mass (or cuboid mass) (e.g. oriented in the Y direction with its longitudinal axis) and a spring-loaded, U-shaped loop structure oriented perpendicularly to the bar mass and pointing towards the rotor 200 and the further rotor 300, at the end of which a substrate anchoring is arranged. The embodiment “f” corresponds to a construction consisting of two mass elements 614, 615 or two further mass elements 624, 625, each of which can be designed independently of one another as one of the embodiments “a”, “b”, “c”, “d”, “e” and are connected by a connecting element 618 or a further connecting element 628 which is present in one of the embodiments from FIG. 6 (i.e., in one of the embodiments “a”, “b”, “c”, “d” or “e” of FIG. 6).

The present disclosure is not limited to the above-described exemplary embodiments, but rather can be used in a wide variety of applications of inertial sensor-based navigation, orientation, and stabilization of objects. A computing unit in the sensor can be used to control the operation of the inertial sensor (e.g. power saving mode, measuring ranges), to check sensor signals for plausibility and e.g. for tolerances (e.g. for sensor-internal monitoring), to process the signals (e.g. calculating the position or orientation, filtering the data), and to select communication protocols. A wide variety of self-learning AI-based algorithms can be used in the computing unit for the evaluation and signal processing of the data from the inertial sensors, the temperature sensors and external data (e.g. GPS data, odometer data). Fields of application, by way of example, can be found in:

automotive applications (e.g. ESP, roll-over sensing, airbag, road noise suppression, anti-theft alarm, parking collision, road condition monitoring),

for two-wheelers such as motorcycle, bicycle, scooter applications (e.g. in ESP/airbag, inclination detection, balancing),

for three-wheelers such as Tuk-Tuks,

in the avionics sector (e.g. in flight stabilization and flight control),

in industrial robot applications (e.g. in position control of excavator buckets, drilling, image stabilization, flight control, alignment of satellite antennas, fine motor skills in gripping robots)

in home and garden applications (e.g. lawnmower navigation, door position monitoring)

for medical applications (e.g. fall detection, motion and posture detection)

in sports and leisure applications (e.g. motion detection, posture detection (for golf clubs, tennis rackets or skis),

numerous consumer applications e.g. in smartphones, tablets, wearables, hearables, drones, gaming toys, AR or VR.

Furthermore, numerous designs, changes, modifications, deviations, variations and embodiments are possible, all of which fall within the scope of the present disclosure.

What is claimed is:

1. A three-axis gyroscope, comprising:
a first rocker structure;
a second rocker structure; and
a coupling structure including a coupling element and a further coupling element, wherein the coupling element includes at least one mass element and at least one connecting element, wherein the further coupling element includes at least one further mass element and at least one further connecting element;
wherein: (i) the coupling element is a linkage of and/or a series of the at least one mass element with the at least one connecting element, and/or (ii) the further coupling element is a further linkage of and/or a further series of the at least one further mass element with the at least one further connecting element.

2. The three-axis gyroscope according to claim 1, further comprising:
a substrate;
a rotor including a first partial oscillator and a second partial oscillator; and
a further rotor including a first further partial oscillator and a second further partial oscillator;
wherein the first rocker structure is connected to the first partial oscillator and the first further partial oscillator,
wherein the second rocker structure is connected to the second partial oscillator and the second further partial oscillator,
wherein the first rocker structure is connected to the substrate via a first rocker-substrate connection,
wherein the first rocker structure is rotatably arranged about an axis extending through the first rocker-substrate connection and oriented perpendicularly to a main extension plane of the three-axis gyroscope,
wherein the second rocker structure is connected to the substrate via a second rocker-substrate connection,
wherein the second rocker structure is rotatably arranged about an axis extending through the second rocker-substrate connection and oriented perpendicularly to a main extension plane of the three-axis gyroscope.

3. The three-axis gyroscope according to claim 2, wherein:
the first rocker structure is connected to the second rocker structure via the coupling element and/or via the further coupling element,
the coupling element is arranged to a side of the rotor and/or the further coupling element is arranged to a side of the further rotor,
the coupling element is arranged symmetrically mirrored to the further coupling element with respect to a first plane of symmetry of the three-axis gyroscope.

4. The three-axis gyroscope according to claim 3, wherein:
the rotor is connected to the substrate via a rotor-substrate connection, and/or the further rotor is connected to the substrate via a further rotor-substrate connection,
the rotor is connected to the further rotor via a rotor connection structure configured as a spring-loaded bar,
the first plane of symmetry of the three-axis gyroscope passes through the rotor connection structure and/or through the first rocker-substrate connection and/or through the second rocker-substrate connection.

5. The three-axis gyroscope according to claim 4, wherein:
the rotor includes a first electrode and a second electrode, the first electrode and the second electrode being arranged along a connecting axis of the rotor-substrate connection and of the further rotor-substrate connection,
the further rotor has a first further electrode and a second further electrode, the first further electrode and the second further electrode being arranged along a connecting axis of the rotor substrate connection and of the further rotor substrate connection,
the first partial oscillator includes a third electrode and the second partial oscillator includes a fourth electrode,
the first further partial oscillator includes a third further electrode and the second further partial oscillator includes a fourth further electrode,
at least one of the first, second, third, and fourth electrodes and/or at least one of the first, second, third, and fourth further electrodes are arranged: (i) between the substrate and the rotor, or (ii) between the substrate and the further rotor.

6. The three-axis gyroscope according to claim 4, wherein:
the coupling element, at one end of the linkage or at one end of the series, is connected to the first rocker structure via a first coupling rocker connection structure, and, at another end of the linkage or at another end of the series, is connected to the second rocker structure via a second coupling rocker connection structure,
the further coupling element, at one end of the further linkage or at one end of the further series, is connected to the first rocker structure via a first further coupling rocker connection structure, and, at another end of the further linkage or another end of the further series, is connected via a second further coupling rocker connection structure to the second rocker structure.

7. The three-axis gyroscope according to claim 6, wherein:
(i) the coupling element includes has four mass elements and three spring-loaded connecting elements in a linkage and/or in a series, and/or (ii) the further coupling element has four further mass elements and three spring-loaded further connecting elements in a further linkage and/or in a further series,
the coupling element and/or the further coupling element has a symmetry with respect to a second plane of symmetry of the three-axis gyroscope, the second plane of symmetry extending through the rotor-substrate connection and the further rotor-substrate connection and is oriented perpendicularly to the main extension plane.

8. The three-axis gyroscope according to claim 7, wherein:
the coupling element includes a first mass element, a second mass element, a third mass element, and a fourth mass element,
the further coupling element includes a first further mass element, a second further mass element, a third further mass element, and a fourth further mass element;
the coupling element includes a first connecting element, a second connecting element, and a third connecting element, and
the further coupling element includes a first further connecting element, a second further connecting element, and a third further connecting element.

9. The three-axis gyroscope according to claim 8, wherein:
the first connecting element connects the first mass element to the second mass element, the second connecting element connects the second mass element to the third mass element, and the third connecting element connects the third mass element to the fourth mass element;
the first further connecting element connects the first further mass element to the second further mass element, the second further connecting element connects the second further mass element to the third further mass element, and the third further connecting element connects the third further mass element to the fourth further mass element,
the first rocker structure is connected to the first mass element using the first coupling rocker connection structure and is connected to the first further mass element using the first further coupling rocker connection structure,
the second rocker structure is connected to the fourth mass element using the second coupling rocker connection structure and is connected to the fourth further mass element using the second further coupling rocker connection structure.

10. The three-axis gyroscope according to claim 9, wherein:
the first mass element is identical in construction to the fourth mass element and/or is arranged mirror-symmetrically to the fourth mass element,
the first further mass element is identical in construction to the fourth further mass element and/or is arranged mirror-symmetrically to the fourth further mass element,
the second mass element is identical in construction to the third mass element and/or is arranged mirror-symmetrically to the third mass element,
the second further mass element is identical in construction to the third further mass element and/or is arranged mirror-symmetrically to the third further mass element.
